(19) United States
(12) Patent Application Publication
(10) Pub. No.: US 2025/0233369 A1
(43) Pub. Date: Jul. 17, 2025

(54) CABLE CONNECTING DEVICE WITH REDUCED INTERFERENCE ON SIGNALS

(71) Applicant: James Cheng Lee, La Habra, CA (US)

(72) Inventor: James Cheng Lee, La Habra, CA (US)

(21) Appl. No.: 19/013,062

(22) Filed: Jan. 8, 2025

Related U.S. Application Data
(60) Provisional application No. 63/621,138, filed on Jan. 16, 2024.

(30) Foreign Application Priority Data
Dec. 19, 2024 (CN) 202411881406.5

(51) Int. Cl. H01R 13/6591; H01R 12/70

(52) U.S. Cl. CPC H01R 13/6591; H01R 12/707

(57) ABSTRACT

A cable connecting device with reduced interference on signals, including: a casing; a printed circuit board provided inside the casing and having first pads and a second pad; a metal ground spring plate soldered to the second pad and abuts against an inner wall of the casing; a connector having pins soldered to the printed circuit board; a front cover provided at one end of the casing and located inside the one end of the casing; a metal wire clip provided at another end of the casing; a cable, one end of which passes through the other end of the casing and is arranged inside the metal wire clip, and the cable has ground wires soldered to the first pads. Thereby, the cable connecting device of the present invention can provide a second ground loop that enables a faster reduction in ground impedance, to reduce the interference on signals.

### CROSS-REFERENCE TO RELATED APPLICATION

This application claims the priority of U.S. Provisional Application No. 63/621,138, filed on Jan. 16, 2024 and Chinese patent application No. 202411881406.5, filed on Dec. 19, 2024, which are incorporated herewith by reference.

### BACKGROUND OF THE INVENTION

### 1. Field of the Invention

The present invention relates to a cable connecting device, in particular to a cable connecting device with reduced interference on signals.

### 2. The Prior Arts

In general electronic equipment, grounding is an important method to control interference. Most interference problems can be solved if grounding and casing are used by a correct combination. In the circuit design of electronic equipment, the casing is mainly used as a ground wire to connect to the ground, so as to become a potential reference point inside the circuit. Grounding can also be regarded as a common return path for current (i.e., a ground loop).

The circuit of a conventional cable connecting device includes the following design considerations:
(1) The braided ground wire at the periphery of the raw cable and the auxiliary individual bare ground wire inside the cable are soldered to the pads on the printed circuit board, and then connected to the casing through the soldering pins in the USB Type-C connector, the casing is soldered to a metal wire clip at the rear end of the raw cable, and the metal wire clip is wrapped around the braided ground wire of the raw cable, thereby forming a ground loop.
(2) If the ground wire is very thin, the ground potential will change as the current changes, causing the timing signal level of the electronic equipment to be unstable and the anti-noise performance to deteriorate. Therefore, users commonly make the ground wire as thick as possible such that the allowed current on the printed circuit board can pass through the ground wire.
(3) There are several integrated circuits on the printed circuit board, especially when there are components that consume more power, due to the limitation of the diameter of the ground wire, a large potential difference will be generated on the ground wire, thereby causing a decrease in anti-noise ability. Therefore, when the cable only has the ground wire system of printed circuit board composed of digital circuits, if the ground wire forms a closed loop, the value of the potential difference will be reduced and the anti-noise ability of the electronic equipment will be improved.

However, in the conventional cable connecting devices, the path of the ground loop is longer, resulting a slower reduction in ground impedance.

Furthermore, in conventional cable connecting devices, the effect of reducing interference on signals is generally achieved by increasing the number or diameter of the ground wires, however, it causes that the cable connecting device is too stiff to be bent.

### SUMMARY OF THE INVENTION

A main object of the present invention is to provide a cable connecting device with reduced interference on signals, in which the path of the ground loop is shorter, achieving a faster reduction in ground impedance.

Another object of the present invention is to provide a cable connecting device with reduced interference on signals without a need of increasing the number or diameter of the ground wires.

In order to achieve the above objects, the present invention provides a cable connecting device with reduced interference on signals, comprising a casing, a printed circuit board, a metal ground spring plate, a connector, a front cover, a metal wire clip and a cable. The printed circuit board is provided inside the casing and has a plurality of first pads and a second pad, wherein the first pads are close to a second end of the printed circuit board, and the second pad is arranged between a first end of the printed circuit board and the first pads. The metal ground spring plate is soldered to the second pad and abuts against an inner wall of the casing. The connector is provided at one end of the casing, protrudes outward from the one end of the casing, and has a plurality of pins soldered to the first end of the printed circuit board. The front cover is provided at one end of the casing and located inside the one end of the casing. The metal wire clip is provided at another end of the casing. One end of the cable passes through the other end of the casing and is arranged inside the metal wire clip, and the cable has a plurality of ground wires respectively soldered to the first pads.

In some embodiments, the metal ground spring plate includes a positioning portion and a spring plate body, the metal ground spring plate is arranged on the printed circuit board, and the spring plate body is soldered to the second pad and abuts against the inner wall of the metal shield.

In some embodiments, the printed circuit board is provided with a positioning hole, and the positioning portion is arranged in the positioning hole.

In some embodiments, the positioning hole penetrates the second pad and the printed circuit board.

In some embodiments, the second pad is close to one side of the printed circuit board.

In some embodiments, the spring plate body is U-shaped.

In some embodiments, the casing includes an outer housing and a metal shield provided inside the outer housing, the printed circuit board is provided inside the metal shield, the metal ground spring plate abuts against an inner wall of the metal shield, the connector is provided at a first end of the metal shield and protrudes outward from a first end of the outer housing, the metal wire clip is provided at a second end of the metal shield, and the one end of the cable passes through a second end of the outer housing.

In some embodiments, the cable connecting device further comprises a front cover, the front cover is provided at the first end of the metal shield and located inside the first end of the outer housing.

The effect of the present invention is in that, in addition to providing a first ground loop same as the prior art, the cable connecting device of the present invention can also provide a second ground loop that enables a faster reduction in ground impedance, to reduce the interference on signals.

Furthermore, since the cable connecting device of the present invention can provide a second ground loop that enables a faster reduction in ground impedance, the interference on signals can be reduced without increasing the number or diameter of the ground wires, making the cable be more flexible and easier be bent.

### BRIEF DESCRIPTION OF THE DRAWINGS

FIG. 1 is a perspective view of a cable connecting device with reduced interference on signals according to the present invention.

FIG. 2 is an exploded view of the cable connecting device with reduced interference on signals according to the present invention.

FIG. 3 is a cross-sectional view taken along line III-III in FIG. 1.

FIG. 4 is a see-through view of the cable connecting device with reduced interference on signals according to the present invention.

### DETAILED DESCRIPTION OF THE PREFERRED EMBODIMENT

Herein after, a more detailed description of the implementations of the present invention is made with reference to drawings and reference numerals, in order that those skilled in the art can implement them after studying this specification.

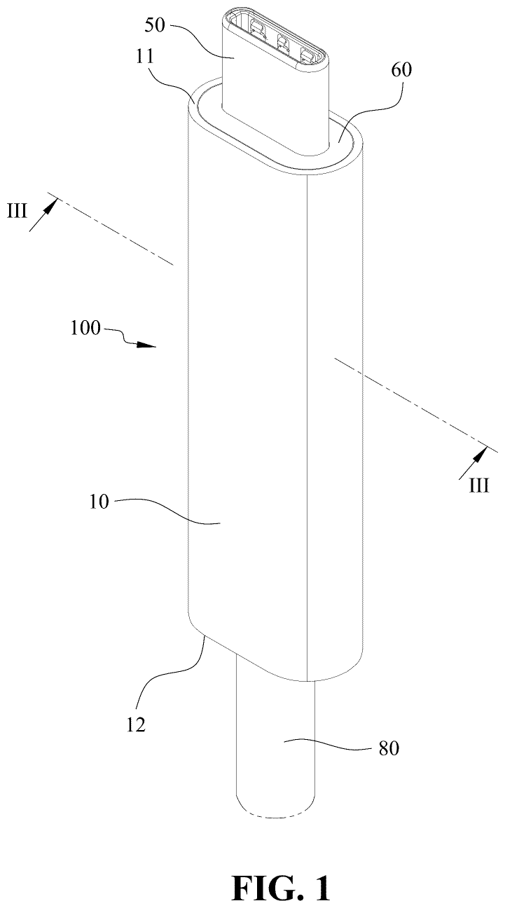

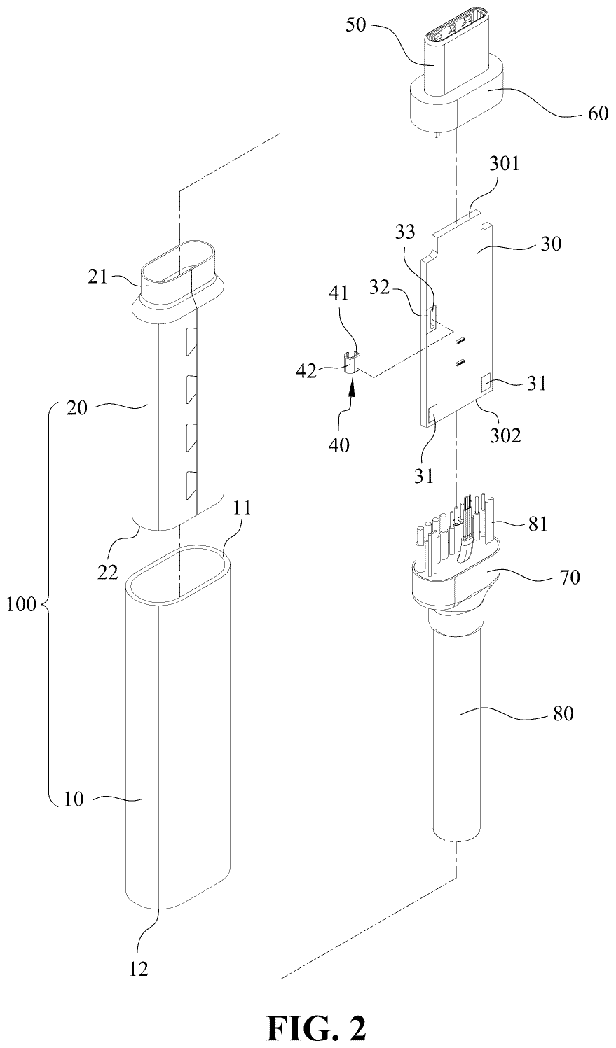

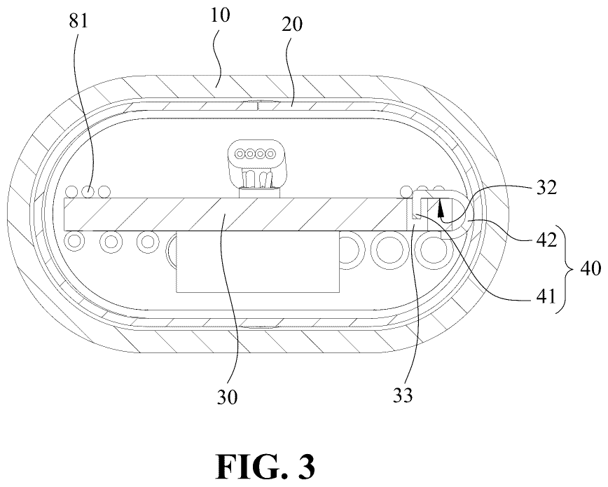

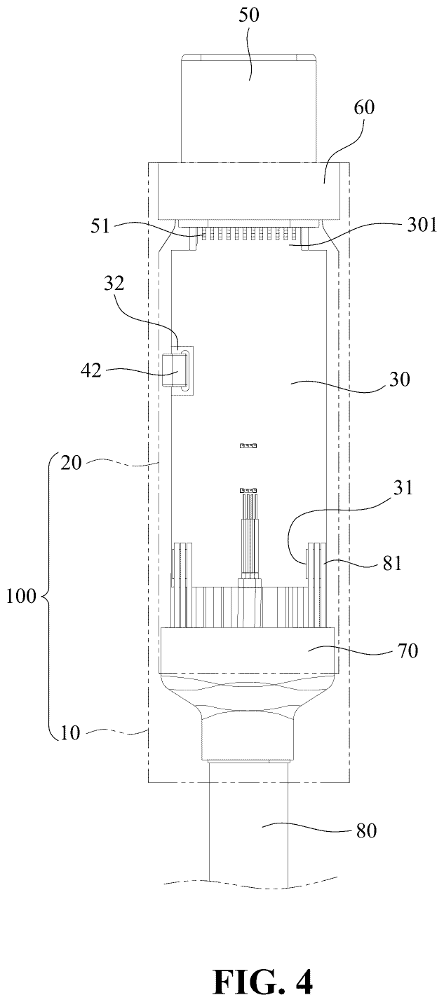

FIG. 1 is a perspective view of a cable connecting device with reduced interference on signals according to the present invention. FIG. 2 is an exploded view of the cable connecting device with reduced interference on signals according to the present invention. FIG. 3 is a cross-sectional view taken along line III-III in FIG. 1. FIG. 4 is a see-through view of the cable connecting device with reduced interference on signals according to the present invention. As shown in FIGS. 1 to 4, the present invention provides a cable connecting device with reduced interference on signals, comprising a casing 100, a printed circuit board 30, a metal ground spring plate 40, a connector 50, a front cover 60, a metal wire clip 70, and a cable 80. The printed circuit board 30 is provided inside the casing 100 and has a plurality of first pads 31 and a second pad 32, wherein the first pads 31 are close to a second end 302 of the printed circuit board 30, and the second pad 32 is arranged between a first end 301 of the printed circuit board 30 and the first pads 31; in other words, compared with the first end 301 of the printed circuit board 30, the second pad 32 is located closer to the first pads 31. The metal ground spring plate 40 is soldered to the second pad 32 and abuts against an inner wall of the casing 100. The connector 50 is provided at one end of the casing 100, protrudes outward from the one end of the casing 100, and has a plurality of pins 51 soldered to the first end 301 of the printed circuit board 30. The front cover 60 is provided at the one end of the casing 100 and is located inside the one end of the casing 100. The metal wire clip 70 is provided at another end of the casing 100. One end of the cable 80 passes through the other end of the casing 100 and is arranged inside the metal wire clip 70, and the cable 80 has a plurality of ground wires 81 respectively soldered to the first pads 31.

The two ground loops of the cable connecting device of the present invention will be further described below.

The first ground loop follows the sequence of: (1) the ground wires 81 of the cable 80; (2) the printed circuit board 30; (3) the pins 51 of the connector 50; (4) the one end of the casing 100; (5) a side wall of the casing 100; (6) the metal wire clip 70; and (7) the braided ground wires inside the cable 80 (not shown).

The second ground loop follows the sequence of: (1) the ground wires 81 of the cable 80; (2) the printed circuit board 30; (3) the metal ground spring plate 40; (4) the side wall of the casing 100; (5) the metal wire clip 70; and (6) the braided ground wires inside the cable 80 (not shown).

Since the second pad 32 is located closer to the first pads 31, the distance from the ground wires 81 of the cable 80 to the metal ground spring plate 40 is significantly shorter than that from the ground wires 81 of the cable 80 to the pins 51 of the connector 50. Compared with the path of the first ground loop, the path of the second ground loop is significantly shorter, which enables a faster reduction in ground impedance. Therefore, in addition to providing a first ground loop same as the prior art, the cable connecting device of the present invention can also provide a second ground loop that enables a faster reduction in ground impedance, to reduce the interference on signals.

Furthermore, since the cable connecting device of the present invention can provide a second ground loop that enables a faster reduction in ground impedance, the interference on signal can be reduced without increasing the number or diameter of the ground wires 81, making the cable 80 be more flexible and easier be bent.

In addition, the metal ground spring plate 40 can be always kept in contact with the casing 100 due to its elasticity, and thus can be served as a bridge structure that directly conducts the casing 100 and the printed circuit board 30, thereby maintaining the conduction of the second ground loop.

As shown in FIGS. 2, 3 and 4, in a preferred embodiment, the metal ground spring plate 40 includes a positioning portion 41 and a spring plate body 42. The metal ground spring plate 40 is arranged on the printed circuit board 30, and the spring plate body 42 is soldered to the second pad 32 and abuts against the inner wall of the casing 100. Therefore, the positioning portion 41 can be firmly fixed on the printed circuit board 30 to prevent the metal ground spring plate 40 from detaching from the printed circuit board 30. Furthermore, the spring plate body 42 can be always kept in contact with the casing 100 due to its elasticity, and thus can be served as a bridge structure that directly conducts the casing 100 and the printed circuit board 30, thereby maintaining the conduction of the second ground loop.

Preferably, the printed circuit board 30 is provided with a positioning hole 33, and the positioning portion 41 is arranged in the positioning hole 33. Accordingly, the positioning hole 33 can provide a good fixing effect for the positioning portion 41.

As shown in FIGS. 2, 3 and 4, in a preferred embodiment, the second pad 32 is close to one side of the printed circuit board 30. Therefore, the spring plate body 42 can contact the casing 100 without setting the spring plate body 42 with a width being too wide, which reduces the size and the manufacturing cost of the metal ground spring plate 40, and also achieves the effect of easy assembly.

As shown in FIGS. 2 and 3, in a preferred embodiment, the spring plate body 42 is U-shaped. Compared with other shapes, the U-shaped spring plate body 42 has relatively excellent elasticity and can more closely contact the arc-shaped inner wall of the casing 100.

As shown in FIG. 3, in a preferred embodiment, the positioning hole 33 penetrates the second pad 32 and the printed circuit board 30. Therefore, no matter whether the positioning portion 41 has a longer length and passes through the positioning hole 33, or has a shorter length and is concealed in the positioning hole 33, the positioning portion 41 can be smoothly assembled in the positioning hole 33 without being affected by the length of the positioning portion 41.

In a preferred embodiment, the metal ground spring plate 40 is made of copper alloy or gold-plated materials. Furthermore, materials such as copper alloys or gold-plated materials have high conductivity, which helps reduce the transmission impedance. However, the present invention is not limited thereto, and any metal can be used as the material of the metal ground spring plate 40 of the present invention.

As shown in FIGS. 1 to 4, in a preferred embodiment, the casing 100 includes an outer housing 10 and a metal shield 20 provided inside the outer housing 10, the printed circuit board 30 is provided inside the metal shield 20, the spring plate body 42 abuts against the inner wall of the metal shield 20, the connector 50 is provided at a first end 21 of the metal shield 20 and protrudes outward from a first end of the outer housing 10, the front cover 60 is provided at the first end 21 of the metal shield 20 and is located inside the first end 11 of the outer housing 10, the metal wire clip 70 is provided at a second end 22 of the metal shield 20, and one end of the cable 80 passes through a second end 12 of the outer housing 10.

The two ground loops of the cable connecting device according to the preferred embodiment of the present invention will be further described below.

The first ground loop follows the sequence of: (1) the ground wires 81 of the cable 80; (2) the printed circuit board 30; (3) the pins 51 of the connector 50; (4) the first end 21 of the metal shield 20; (5) a side wall of the metal shield 20; (6) the metal wire clip 70; and (7) the braided ground wires inside the cable 80 (not shown).

The second ground loop follows the sequence of: (1) the ground wires 81 of the cable 80; (2) the printed circuit board 30; (3) the metal ground spring plate 40; (4) the first end 40 of the metal shield 20; (4) the side wall of the metal shield 20; (5) the metal wire clip 70; and (6) the braided ground wires inside the cable 80.

In some embodiments, the outer housing 10 and the metal shield 20 of the casing 100 may be integrally formed.

Those mentioned above are only used to explain the preferred embodiments of the present invention, and are not intended to limit the present invention in any form. Therefore, any modifications or changes to the present invention made under the same creative spirit should still be included in the scope to be protected of the present application.

What is claimed is:

1. A cable connecting device with reduced interference on signals, comprising:
a casing;
a printed circuit board provided inside the casing and having a plurality of first pads and a second pad, wherein the first pads are close to a second end of the printed circuit board, and the second pad is arranged between a first end of the printed circuit board and the first pads;
a metal ground spring plate soldered to the second pad and abuts against an inner wall of the casing;
a connector provided at one end of the casing, protruding outward from the one end of the casing, and having a plurality of pins soldered to the first end of the printed circuit board;
a metal wire clip provided at another end of the casing; and
a cable, one end of which passes through the other end of the casing and is arranged inside the metal wire clip, and the cable has a plurality of ground wires respectively soldered to the first pads.

2. The cable connecting device according to claim 1, wherein the metal ground spring plate includes a positioning portion and a spring plate body, the metal ground spring plate is arranged on the printed circuit board, and the spring plate body is soldered to the second pad and abuts against the inner wall of the casing.

3. The cable connecting device according to claim 2, wherein the printed circuit board is provided with a positioning hole, and the positioning portion is arranged in the positioning hole.

4. The cable connecting device according to claim 3, wherein the positioning hole penetrates the second pad and the printed circuit board.

5. The cable connecting device according to claim 2, wherein the second pad is close to one side of the printed circuit board.

6. The cable connecting device according to claim 2, wherein the spring plate body is U-shaped.

7. The cable connecting device according to claim 1, wherein the casing includes an outer housing and a metal shield provided inside the outer housing, the printed circuit board is provided inside the metal shield, the metal ground spring plate abuts against an inner wall of the metal shield, the connector is provided at a first end of the metal shield and protrudes outward from a first end of the outer housing, the metal wire clip is provided at a second end of the metal shield, and the one end of the cable passes through a second end of the outer housing.

8. The cable connecting device according to claim 7, further comprising a front cover, the front cover is provided at the first end of the metal shield and located inside the first end of the outer housing.
